(19) United States
(12) Patent Application Publication
(10) Pub. No.: US 2023/0058890 A1
(43) Pub. Date: Feb. 23, 2023

(54) DIRECT BONDING GUIDE SYSTEMS

(71) Applicant: uLab Systems, Inc., Memphis, TN (US)

(72) Inventor: Christian KENWORTHY, Memphis, TN (US)

(73) Assignee: uLab Systems, Inc., Memphis, TN (US)

(21) Appl. No.: 17/664,777

(22) Filed: May 24, 2022

Related U.S. Application Data
(60) Provisional application No. 63/234,805, filed on Aug. 19, 2021.

(51) Int. Cl. A61C 7/14

(52) U.S. Cl. CPC A61C 7/146

(57) ABSTRACT

Direct bonding guide systems are described herein. A template guide may be used for positioning an orthodontic attachment and may generally comprise a formed body defining a receiving channel configured to conform to an occlusal surface of one or more teeth of a patient. A remainder of surfaces of the one or more teeth may remain exposed and a reference surface or shelf may extend along a length of the formed body and project at a predetermined angle. The reference surface may be configured for locating a bracket attachment upon the surfaces of the one or more teeth.

### CROSS-REFERENCE TO RELATED APPLICATIONS

This application claims priority to U.S. Patent Application No. 63/234,805 filed Aug. 19, 2021, the content of which is incorporated herein by reference in its entirety.

### FIELD OF THE INVENTION

The present invention relates to methods and apparatus for orthodontics. More particularly, the present invention relates to methods and apparatus for facilitating the planning and bonding of orthodontic brackets upon teeth for an orthodontic treatment.

### BACKGROUND OF THE INVENTION

Orthodontics is a specialty of dentistry that is concerned with the study and treatment of malocclusions which can result from tooth irregularities, disproportionate facial skeleton relationships, or both. Orthodontics treats malocclusion through the displacement of teeth via bony remodeling and control and modification of facial growth.

A typical treatment generally involves the placement and positioning of braces upon the teeth of a patient for the purpose of applying a static mechanical force to induce bone remodeling, thereby enabling teeth to move. Braces utilize orthodontic brackets affixed to each tooth and an archwire interface interfacing with each of the brackets. As the teeth respond to the pressure applied via the archwire by shifting their positions, the wires are again tightened to apply additional pressure. Each of the brackets are typically aligned in a pre-planned location on each tooth to ensure that tightening of the archwire will result in a desirable tooth movement.

While orthodontists and other practitioners may utilize appliances for affixing brackets onto the teeth, such as indirect bonding trays, many practitioners prefer to position and directly bond the brackets directly on the teeth. Various trays may be created by utilizing a positive mold of a patient's dentition which may be created from an orthodontic 3D scan. Hence the tray may be customized to each particular patient's dentition. These trays may also be transparent to allow for the practitioner to use to curing light to cement the entire arch of brackets simultaneously.

However, there are also deficiencies with many of these tray systems. For instance, some trays may provide for inadequate space for positioning and placing the brackets upon the surfaces of the teeth. Such trays may limit the ability of the practitioner to vary the positioning of the brackets.

Other trays may provide for a template which defines an aperture or opening at a preset location over the surface of the crown within which the bracket is positioned and secured to the crown surface for subsequently coupling to an archwire. However, such templates provide a limited window within which the bracket must be adhered to the crown surface and limits the flexibility of the practitioner to position the bracket upon the crown surface.

Accordingly, there exists a need for an efficient and effective direct bonding system which facilitates placement of orthodontic brackets.

### SUMMARY OF THE INVENTION

A template guide which is positionable upon the dentition of the patient and which provides a reference surface or shelf may facilitate the rapid attachment of brackets upon the crown surfaces without overly restricting the flexibility or judgment of the practitioner in determining bracket placement. As part of the treatment planning, a three-dimensional (3D) digital scan of the patient's dental arch prior to treatment is typically obtained using any number of scanning methodologies and processes. Using the 3D digital scan, any number of malocclusions may be corrected using various orthodontic appliances such as braces with archwires, aligners, etc.

One variation of a template guide may be formed to correspond to the dentition of the patient's teeth based upon the scanned 3D image. A mold of the patient's dentition may be formed from the digitally scanned image using any number of techniques and the template guide may be fabricated to conform to the dentition or a portion of the dentition. One or more bracket guide attachment members may be formed or positioned upon the surfaces of the crown (buccal or lingual) on the mold in order to form a reference surface or shelf as part of the template guide. Once the template guide has been completed, the guide may be placed upon the dentition of the patient such that the reference surface or shelf provides a guide for readily placing the corresponding bracket upon the surface of the teeth. The template guide may provide the reference surface or shelf upon which the practitioner may move the bracket left or right relative to the midline of each crown (or directly upon the midline) by utilizing their experience. That is, each bracket may be moved in a mesial or distal position along the reference surface or shelf for attachment upon the crown surface as the shelf may provide the predetermined or ideal positioning along the occlusal or gingival direction (apical or basal) of each crown. As the practitioner may simply slide the bracket along the shelf for positioning upon the crown, the placement of each bracket may be located more easily.

The mold of the dentition may incorporate the one or more bracket guide attachment members formed either directly upon the one or more teeth (buccal or lingual surfaces) or they may be attached separately. The bracket guide attachment members may form an interface surface which extends from the surface of the crown (e.g., buccal surface) upon which the template guide may conform to result in the formation of the reference surface or shelf. Each of the bracket guide attachment members (or a select few) may also incorporate an indicator of where the midline of each crown is located to provide yet another reference point for the practitioner in placing and attaching the bracket upon the teeth.

With the bracket guide attachment members attached or formed upon the mold, the template guide may be formed upon the dentition and bracket guide attachment members such that the template guide are conformed against the occlusal surfaces of the teeth and bracket guide attachment members. In this manner, the resulting template guide may be formed much like an aligner which may be removably placed upon the occlusal surfaces of the patient's teeth and which position the reference surface or shelf to extend away (e.g., orthogonally) from the surface of the teeth (e.g., buccal surfaces).

The dentition of the patient may be digitally scanned either by the practitioner or by a third party to create an electronic digital model of the dentition. This digital model may be received into a treatment planning software which may be used to create and position digital versions of the bracket guide attachment members upon the digital model. Each of the attachment members may be connected laterally along a 3D line in the digital model to an adjacent attachment member to form a continuous line at a distance from the surfaces (e.g., buccal or lingual) of the teeth. The profile of the reference surface or shelf may be derived from this 3D line and the profile may then be extruded towards the base of the digital model (e.g., in the gingival direction) to form the base of the reference surface or shelf. Once the model has been extruded digitally, the model may be cut at the base to reduce the material requirement when fabricated as only half of the model may be used for the actual bonding operations when in use with the patient.

The digital model of the patient's dentition may be received, for example, into a treatment planning software platform which may be used to plan for the steps of correcting any number of malocclusions in the dentition. Once the final position of the patient's teeth have been determined digitally, a position of where the attachment bracket should be attached upon the one or more teeth may be identified in the digital model. The attachment bracket may be positioned at a predetermined distance from each incisal edge of the patient's teeth when in their final positions as these distances will remain unchanged from the initial position of the teeth and the final position of the teeth. These distances may then be used to determine the location of each bracket attachment upon each crown for forming the reference surface or shelf.

The correction of one or more of the teeth may be performed using a treatment planning software platform, as described herein, to result in a final position of the dentition where a position of one or more of the teeth have been corrected. With the one or more teeth in their final position, the bracket guide attachment members may be digitally applied upon the one or more teeth at locations where the brackets can be applied. Each of the bracket guide attachment members (or just a selected number) may include an indicator or projection extending from the member such that the attachment member may be applied upon the crown to align the indicator or projection along a mid-line of the crown to provide an additional guide to the practitioner. Once the attachment members may been applied to the teeth in their final position, the teeth may be reverted back to their initial position with the attachment members still positioned upon each of the teeth.

Once the individual attachment members are positioned upon the teeth and the digital model of the dentition is reverted back to its initial position, the individual attachment members on each of the teeth may be connected laterally to an adjacent attachment to form a continuous line at a distance from the buccal surfaces of the teeth. The profile of the reference surface or shelf may be derived from this 3D line and the profile may then be extruded towards the base of the digital model (e.g., in the gingival direction) to form the base of the reference surface or shelf. Once the model has been extruded digitally, the model may be cut at the base to reduce the material requirement when fabricated.

With the digital model created of the teeth in their initial position, a positive mold of the dentition with attachment members and reference surface or shelf may be fabricated and a template guide may be formed upon the mold. The resulting template guide may correspondingly fit upon the dentition of the patient having the reference surface or shelf formed. Alternatively, the template guide may be fabricated directly using any number of direct printing or additive fabrication techniques to form the resulting template guide.

With the template guide secured upon the patient's teeth, the practitioner may position an orthodontic bracket attachment upon the surface of the crown. As the reference surface or shelf is already situated along the occlusal-gingival direction, the practitioner may utilize the reference surface or shelf for positioning the bracket attachment upon so that the practitioner may move the attachment in a mesial or distal direction (e.g., left or right) upon the crown relative to the groove or mark indicating the crown mid-line. While the practitioner may secure the attachment upon the crown at the mid-line of the groove or mark, they may also use their professional judgement in determining whether to move the attachment in a more mesial or distal position for attachment to the crown to effect any particular desired tooth movement.

Once each of the bracket attachments have been adhered to the respective crown, the template guide may be removed from the dentition to allow for the engagement of the archwire to the bracket attachments. Alternatively, the template guide may be left in place while the archwire is positioned to engage each of the bracket attachments.

The bracket guide attachment members which may be positioned upon the digital model of the dentition or which may be attached or otherwise formed on a mold of the dentition (which may be scanned as a digital model), may be configured in different shapes.

One variation of a template guide for positioning an orthodontic attachment may generally comprise a formed body defining a receiving channel configured to conform to an occlusal surface of one or more teeth of a patient while a remainder of surfaces of the one or more teeth remain exposed and a reference surface or shelf extending along a length of the formed body and projecting at a predetermined angle, wherein the reference surface is configured for locating a bracket attachment upon the surfaces of the one or more teeth.

One variation of a method of forming a template guide for use with an orthodontic attachment may generally comprise receiving a digital model of one or more teeth of a patient, positioning one or more attachments upon the one or more teeth within the digital model, connecting the one or more attachments laterally along a three-dimensional line, deriving a profile from an occlusal plane based on the three-dimensional line, and extruding the profile towards a base of the digital model.

### BRIEF DESCRIPTION OF THE DRAWINGS

FIGS. 1A to 1C illustrate respective front, side, and perspective views of a template guide formed upon the dentition of a patient.

FIG. 2 illustrates one variation for forming a template guide in the flow diagram.

FIG. 3 shows another flow diagram illustrating one variation of the steps for identifying the locations upon the teeth for bracket attachment placement.

FIGS. 4A to 4D illustrate how the digital model may be used in determining the location of the bracket attachments as described in the flow diagram of FIG. 3.

FIG. 5 illustrates a perspective view showing a detail view of the attachment members secured upon the digital model of the teeth with the indicator or projection extending from the occlusal or gingival surface of the attachment member.

FIGS. 6A and 6B illustrate perspective views of the digital model of the dentition.

FIGS. 7A to 7C illustrate detailed perspective, side, and top views of the attachment members connected to adjacent attachment members to form a continuous reference surface or shelf which may extend along the length of the dentition or a portion of the dentition where a bracket attachment is to be attached.

FIGS. 8A to 8E illustrate one variation for positioning the template guide upon the patient's dentition and positioning the one or more bracket attachments.

FIGS. 9A and 9B illustrate perspective views of one variation of a bracket guide attachment member having a body which presents a curved surface.

FIGS. 10A to 10D illustrate respective top, rear, front, and side views of the bracket guide attachment member of FIG. 9A to illustrate each of the respective surfaces.

FIGS. 11A and 11B illustrate perspective views of another variation of a bracket guide attachment member having a body which presents a curved surface and a groove defined along the reference surface.

FIGS. 12A to 12D illustrate respective top, rear, front, and side views of the bracket guide attachment member of FIG. 12A to illustrate each of the respective surfaces.

### DETAILED DESCRIPTION OF THE INVENTION

While the brackets to be bonded to the surface of the crown may be freely placed using the experience of the practitioner, a template guide which is positionable upon the dentition of the patient and which provides a reference surface or shelf may facilitate the rapid attachment of brackets upon the crown surfaces without overly restricting the flexibility or judgment of the practitioner in determining bracket placement.

As part of the treatment planning, a three-dimensional (3D) digital scan of the patient's dental arch prior to treatment is typically obtained using any number of scanning methodologies and processes. Using the 3D digital scan, any number of malocclusions may be corrected using various orthodontic appliances such as braces with archwires, aligners, etc. Particular treatment planning processes are described in further detail in U.S. Pat. Nos. 10,624,717; 10,335,250; 10,631,953; 10,357,336; 10,357,342; 10,588,723; 10,548,690, as well as U.S. Pat. Pubs. 2017/0100208; 2019/0321135; 2020/0205936; 2019/0343602; 2020/0170762; 2018/0078343; 2018/0078344; 2018/0078335; 2020/0146775. The details of these references are incorporated herein by reference in their entirety and for any purpose.

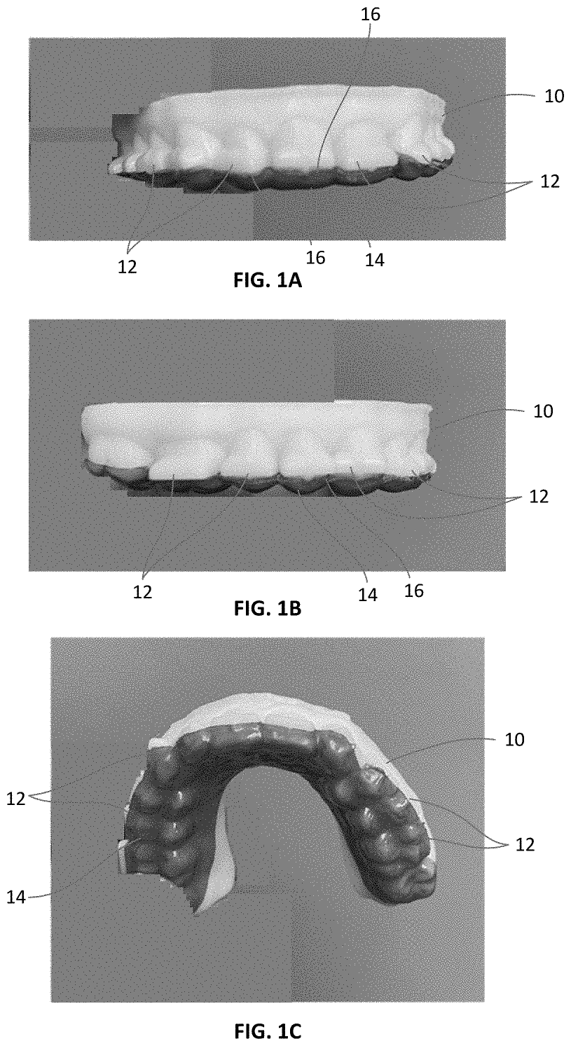

One variation of a template guide is illustrated in the front, side, and perspective views of FIGS. 1A to 1C which show a template guide 14 which is formed to correspond to the dentition of the patient's teeth based upon the scanned 3D image. A mold 10 of the patient's dentition may be formed from the digitally scanned image using any number of techniques and the template guide 14 may be fabricated to conform to the dentition or a portion of the dentition. One or more bracket guide attachment members 12 may be formed or positioned upon the surfaces of the crown (buccal or lingual) on the mold 10 in order to form a reference surface or shelf 16 as part of the template guide 14. Once the template guide 14 has been completed, the guide 14 may be placed upon the dentition of the patient such that the reference surface or shelf 16 provides a guide for readily placing the corresponding bracket upon the surface of the teeth. The template guide 14 may provide the reference surface or shelf 16 upon which the practitioner may move the bracket left or right relative to the midline of each crown (or directly upon the midline) by utilizing their experience. That is, each bracket may be moved in a mesial or distal position along the reference surface or shelf 16 for attachment upon the crown surface as the shelf 16 may provide the predetermined or ideal positioning along the occlusal or gingival direction (apical or basal) of each crown. As the practitioner may simply slide the bracket along the shelf 16 for positioning upon the crown, the placement of each bracket may be located more easily.

As shown, the mold 10 of the dentition may incorporate the one or more bracket guide attachment members 12 formed either directly upon the one or more teeth (buccal or lingual surfaces) or they may be attached separately. The bracket guide attachment members 12 may form an interface surface which extends from the surface of the crown (e.g., buccal surface) upon which the template guide 14 may conform to result in the formation of the reference surface or shelf 16. Each of the bracket guide attachment members 12 (or a select few) may also incorporate an indicator of where the midline of each crown is located to provide yet another reference point for the practitioner in placing and attaching the bracket upon the teeth.

With the bracket guide attachment members 12 attached or formed upon the mold 10, the template guide 14 may be formed upon the dentition and bracket guide attachment members 12 such that the template guide 14 are conformed against the occlusal surfaces of the teeth and bracket guide attachment members 12. In this manner, the resulting template guide 14 may be formed much like an aligner which may be removably placed upon the occlusal surfaces of the patient's teeth and which position the reference surface or shelf 16 to extend away (e.g., orthogonally) from the surface of the teeth (e.g., buccal surfaces).

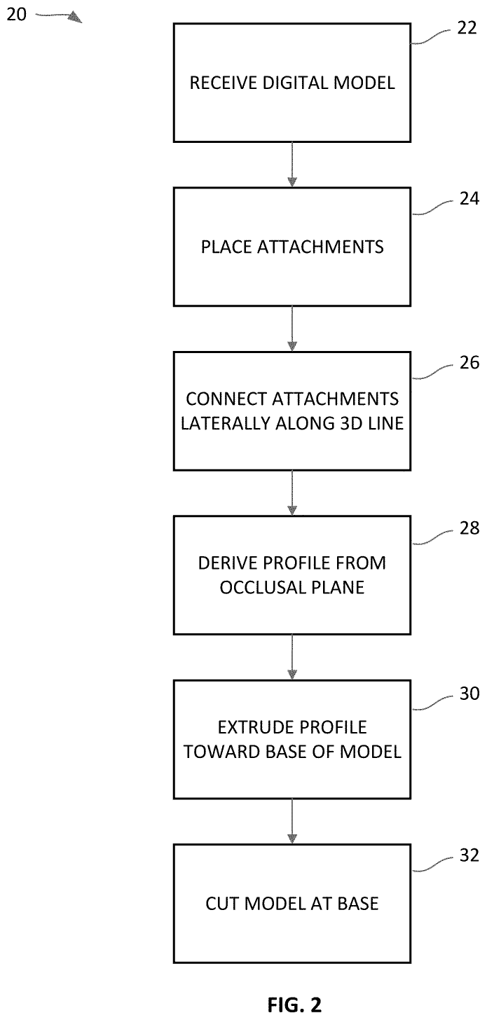

FIG. 2 illustrates one variation for forming a template guide in the flow diagram 20. The dentition of the patient may be digitally scanned either by the practitioner or by a third party to create an electronic digital model of the dentition. This digital model may be received 22 into a treatment planning software, as described herein, which may be used to create and position digital versions of the bracket guide attachment members 24 upon the digital model. Each of the attachment members may be connected laterally along a 3D line 26 in the digital model to an adjacent attachment member to form a continuous line at a distance from the surfaces (e.g., buccal or lingual) of the teeth. The profile of the reference surface or shelf may be derived from this 3D line 28 and the profile may then be extruded towards the base of the digital model (e.g., in the gingival direction) 30 to form the base of the reference surface or shelf. Once the model has been extruded digitally, the model may be cut at the base 32 to reduce the material requirement when fabricated as only half of the model may be used for the actual bonding operations when in use with the patient.

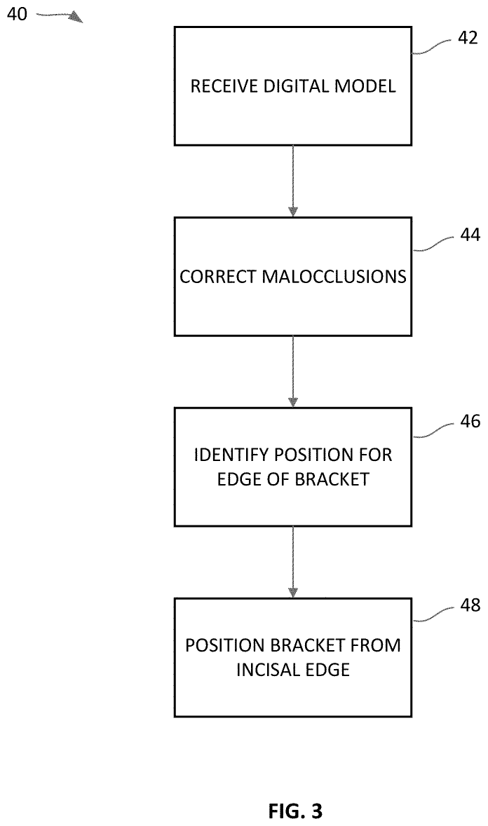

FIG. 3 shows another flow diagram 40 illustrating one variation of the steps for identifying the locations upon the teeth for bracket attachment placement. As described herein, the digital model of the patient's dentition may be received 42, for example, into a treatment planning software platform which may be used to plan for the steps of correcting any number of malocclusions 44 in the dentition. Once the final position of the patient's teeth have been determined digitally, a position of where the attachment bracket should be attached upon the one or more teeth may be identified 46 in the digital model. The attachment bracket may be positioned at a predetermined distance from each incisal edge 48 of the patient's teeth when in their final positions as these distances will remain unchanged from the initial position of the teeth and the final position of the teeth. These distances may then be used to determine the location of each bracket attachment upon each crown for forming the reference surface or shelf.

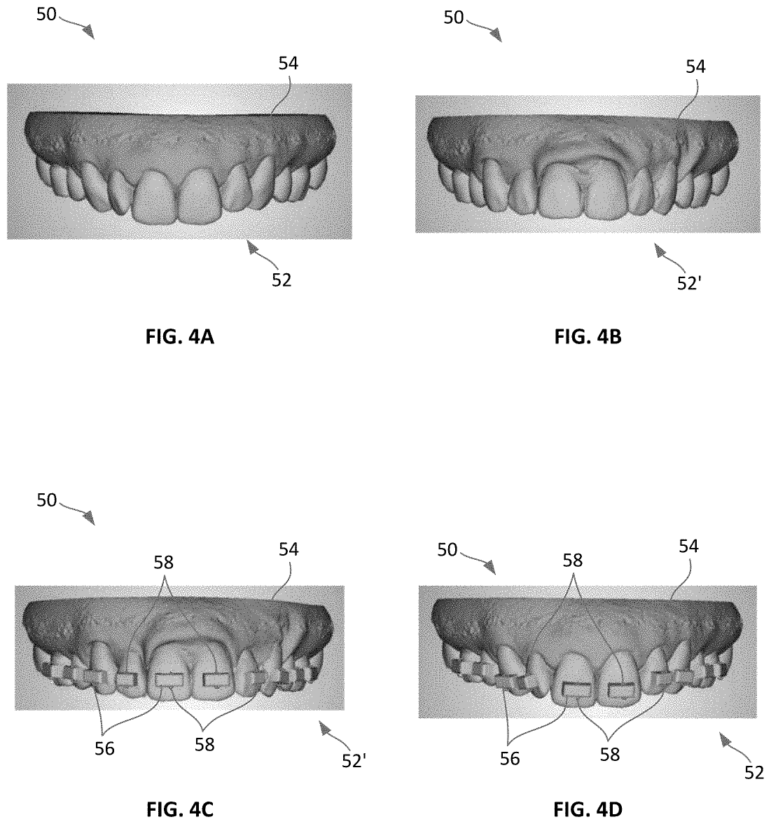

FIGS. 4A to 4D illustrate how the digital model may be used in determining the location of the bracket attachments as described in the flow diagram 40. With the digital model of the patient's dentition 50, the upper dentition 54 of the patient is illustrated in the front view of FIG. 4A with the teeth in their initial position 52 prior to correction. The correction of one or more of the teeth may be performed using a treatment planning software platform, as described herein, to result in a final position 52′ of the dentition where a position of one or more of the teeth have been corrected, as shown in the front view of FIG. 4B. With the one or more teeth in their final position 52′, the bracket guide attachment members 56 may be digitally applied upon the one or more teeth at locations where the brackets can be applied, as shown in FIG. 4C. Each of the bracket guide attachment members 56 (or just a selected number) may include an indicator or projection 58 extending from the member such that the attachment member 56 may be applied upon the crown to align the indicator or projection 58 along a mid-line of the crown to provide an additional guide to the practitioner. Once the attachment members 56 may been applied to the teeth 52′ in their final position, the teeth may be reverted back to their initial position 52 with the attachment members 56 still positioned upon each of the teeth, as shown in FIG. 4D. The digital model shown in FIG. 4D may be utilized to create the template guide for initially positioning the brackets upon the patient's teeth.

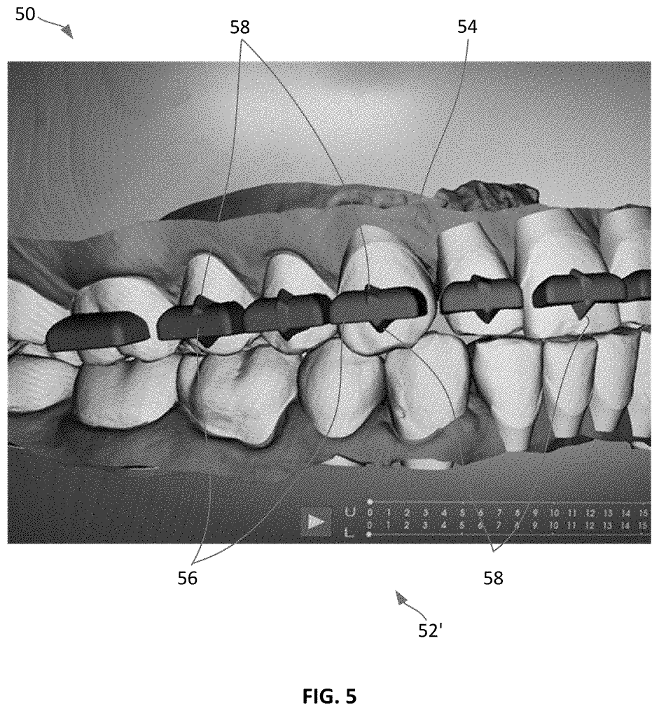

FIG. 5 illustrates a perspective view showing a detail view of the attachment members 56 secured upon the digital model of the teeth with the indicator or projection 58 extending from either occlusal or gingival surface of the attachment member 56. The teeth may be seen in their final position 52′. Furthermore, while several of the attachment members 56 may include the indicator or projection 58, some or all of the attachment members 56 may omit the indicator or projection 58 entirely.

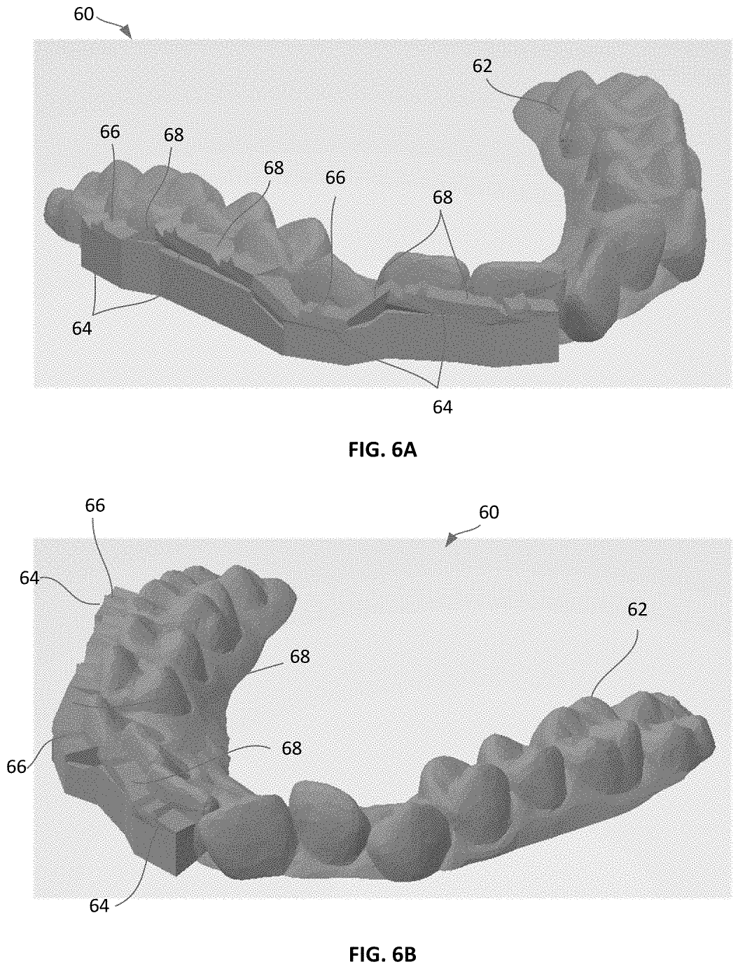

As described, once the individual attachment members are positioned upon the teeth and the digital model of the dentition is reverted back to its initial position, as shown in perspective view of the digital model 60 of FIG. 6A. The individual attachment members 64 on each of the teeth 62 may be connected laterally to an adjacent attachment to form a continuous line at a distance from the buccal surfaces of the teeth. The profile of the reference surface or shelf 68 may be derived from this 3D line and the profile may then be extruded towards the base of the digital model (e.g., in the gingival direction) to form the base of the reference surface or shelf 68. Once the model has been extruded digitally, the model may be cut at the base to reduce the material requirement when fabricated. The indicator or projection 66 may also be seen as a bump or tapered projection to indicate the mid-line of each individual crown. FIG. 6B shows another perspective view of the digital model 60 to illustrate how the reference surface of shelf 68 may extend away from the surfaces of the crown. While only half of the digital model is shown for illustrative purposes, the digital model may be further reduced along a select portion of the dentition or may extend over the entire length of the dentition. Furthermore, the digital model is illustrated as being positioned along the buccal surfaces of the teeth, but in other variations, they may instead be positioned along the lingual surfaces.

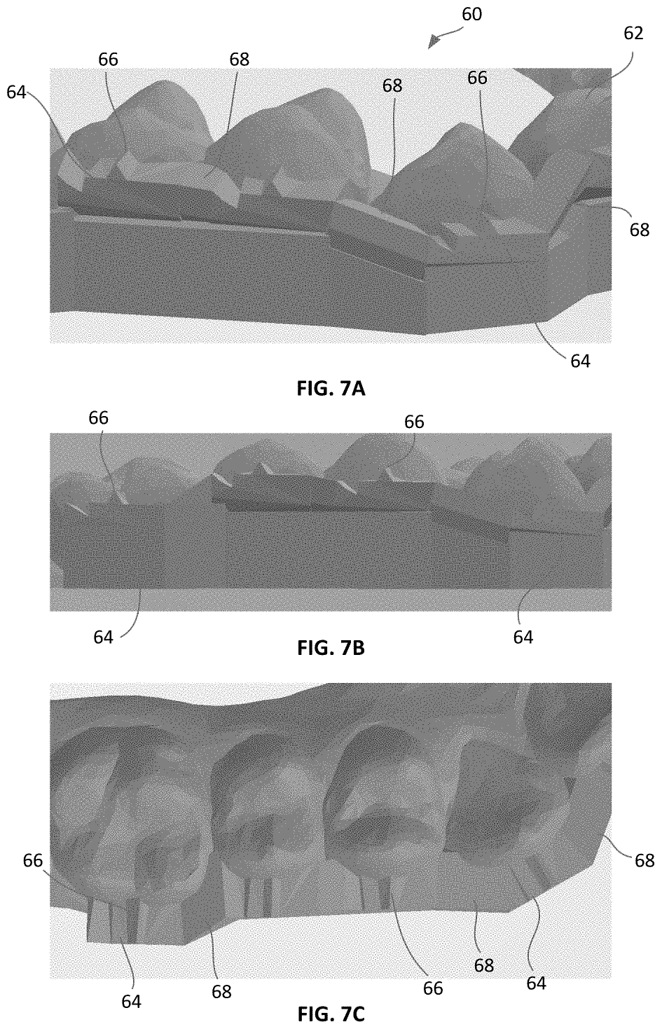

FIGS. 7A to 7C illustrate detailed perspective, side, and top views of the attachment members 64 connected to adjacent attachment members 64 to form a continuous reference surface or shelf 68 which may extend along the length of the dentition or a portion of the dentition where a bracket attachment is to be attached. The indicator or projection 66 along each of the attachment members 64 are also shown indicating the mid-line of each crown.

With the digital model created of the teeth in their initial position, as described herein, a positive mold of the dentition with attachment members and reference surface or shelf may be fabricated and a template guide 70 may be formed upon the mold. The resulting template guide 70 may correspondingly fit upon the dentition of the patient having the reference surface or shelf formed. Alternatively, the template guide 70 may be fabricated directly using any number of direct printing or additive fabrication techniques to form the resulting template guide 70.

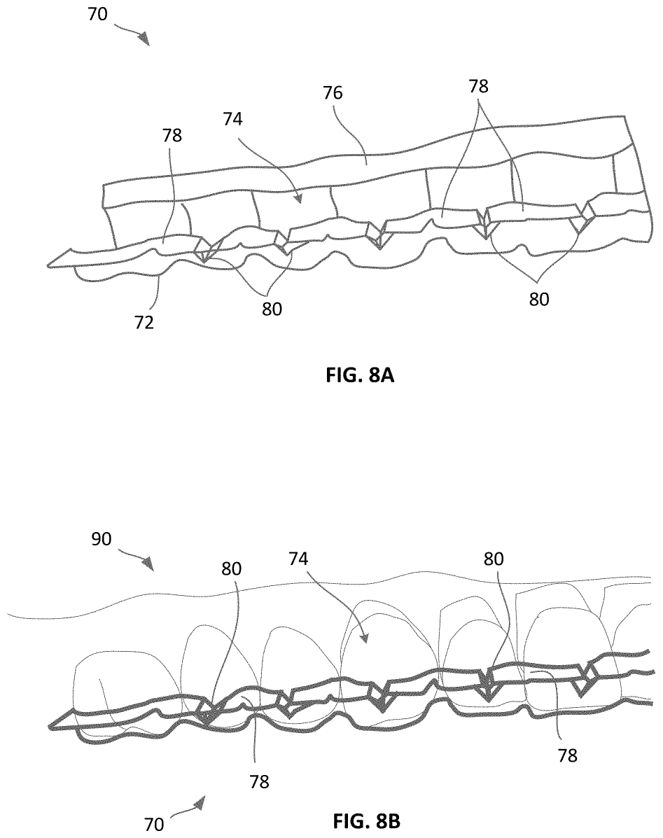

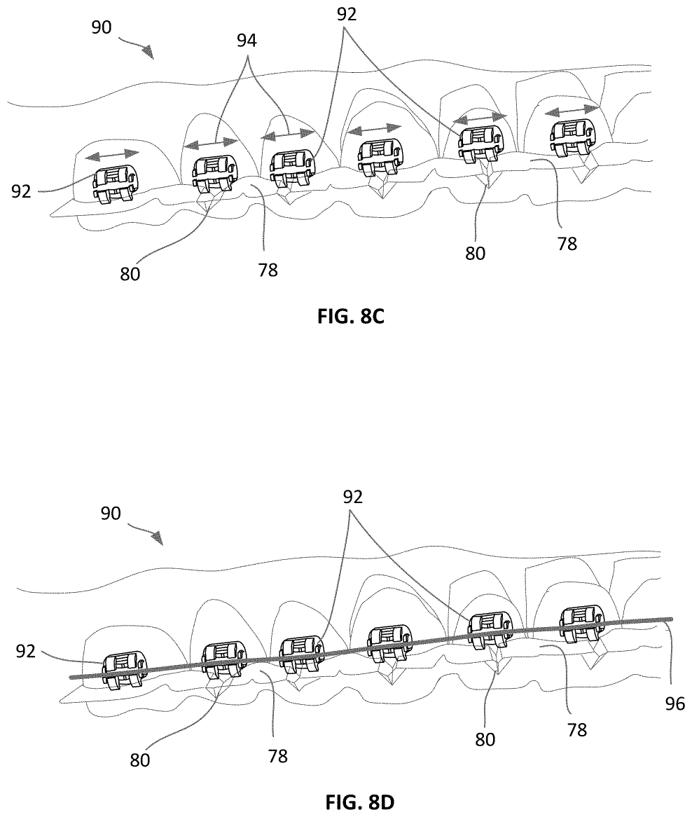

FIG. 8A shows a perspective view of a portion of the fabricated template guide 70 prior to placement upon the patient's dentition. The template guide 70 is shown having a formed body 72 defining a receiving channel 74 which is configured to conform to at least a portion of the patient's dentition, for instance, prior to correcting the positioning of the teeth. The formed body 72 may accordingly be formed to be positioned upon and conform to a portion of the dentition (e.g., one or more teeth), or the formed body 72 may be configured to be positioned upon and conform to the entire dentition. The template guide 70 may have an inner portion 76 which extends along the lingual surfaces of the teeth and optionally up to or over the gums of the patient. The outer portion of the template guide 70 may form the reference surface or shelf 78 which projects or extends away from the formed body 72 (e.g., 1 mm, 2 mm, 3 mm, 4 mm, 5 mm, or greater) at a predetermined angle (e.g., 90 degrees, less than 90 degrees, or greater than 90 degrees relative to a surface of the crown). The reference surface or shelf 78 may also define grooves or marks 80 formed from the indicator or projection 58 of the attachment bracket such that when the template guide 70 is positioned upon the patient's dentition, the grooves or marks 80 may indicate the mid-line position of each corresponding crown, as shown in the perspective view of FIG. 8B, which shows the template guide 70 placed upon the teeth of the patient. As shown, as the receiving channel 74 conforms to the one or more teeth of the patient, the reference surface or shelf 78 may extend away from the buccal surfaces of the teeth to form a continuous surface along the guide 70 with the grooves or marks 80 positioned at each respective crown mid-line. Hence, only a portion of the teeth are covered by the guide 70 over the occlusal surfaces and from the occlusal surfaces to a portion along the buccal (or lingual) surface. The crown surface from where a bracket attachment is to be secured and a remainder of the crown surface towards the gingiva may remain uncovered by the guide 70. The opposite surfaces of the crown (for example, the lingual surfaces if the bracket attachments are secured to the buccal surfaces or alternatively, the buccal surfaces if the bracket attachments are secured to the lingual surfaces) may be fully covered by the guide 70 or remain at least partially exposed.

With the template guide 70 secured accordingly, the practitioner may position an orthodontic bracket attachment 92 upon the surface of the crown, as shown in FIG. 8C. As the reference surface or shelf 78 is already situated along the occlusal-gingival direction, the practitioner may utilize the reference surface or shelf 78 for positioning the bracket attachment 92 upon so that the practitioner may move the attachment 92 in a mesial or distal direction 94 (e.g., left or right) upon the crown relative to the groove or mark 80 indicating the crown mid-line. While the practitioner may secure the attachment 92 upon the crown at the mid-line of the groove or mark 80, they may also use their professional judgement in determining whether to move the attachment 92 in a more mesial or distal position for attachment to the crown to effect any particular desired tooth movement. Hence, the reference surface or shelf 78 provides for uninhibited lateral positioning of the bracket attachment 92 upon the surfaces of the one or more teeth. Furthermore, because the reference surface or shelf 78 are not formed as openings or windows, positioning of the bracket attachments 92 is unconstrained not only in the lateral directions (mesial or distal) upon the crown, but positioning is also unconstrained in the gingival direction of the crown.

Although the orthodontic attachments are illustrated as bracket attachments 92, the application of the apparatus and methods described herein are not limited to the use of brackets may include any type of orthodontic attachments which are adhered or otherwise secured to the patient's teeth. Examples of various orthodontic attachments which may be used with the embodiments herein may include, but are not limited to, brackets, aligner attachments, clear aligner attachments, tubes, buttons, motion devices, power arms, etc.

Once each of the bracket attachments 92 have been adhered to the respective crown, the template guide 70 may be removed from the dentition to allow for the engagement of the archwire 96 to the bracket attachments 92. Alternatively, the template guide 70 may be left in place while the archwire 96 is positioned to engage each of the bracket attachments 92, as shown in FIG. 8D. FIG. 8E illustrates a perspective view of the archwire 96 engaged to the bracket attachments 92 with the template guide 70 removed from the dentition.

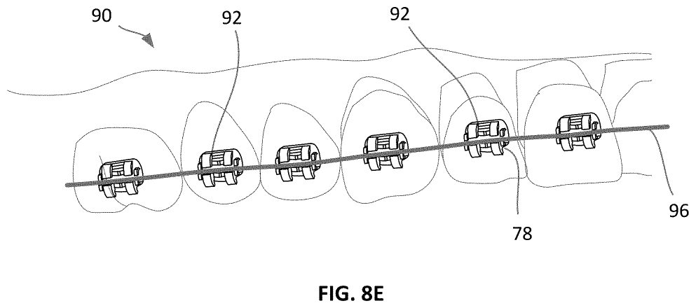

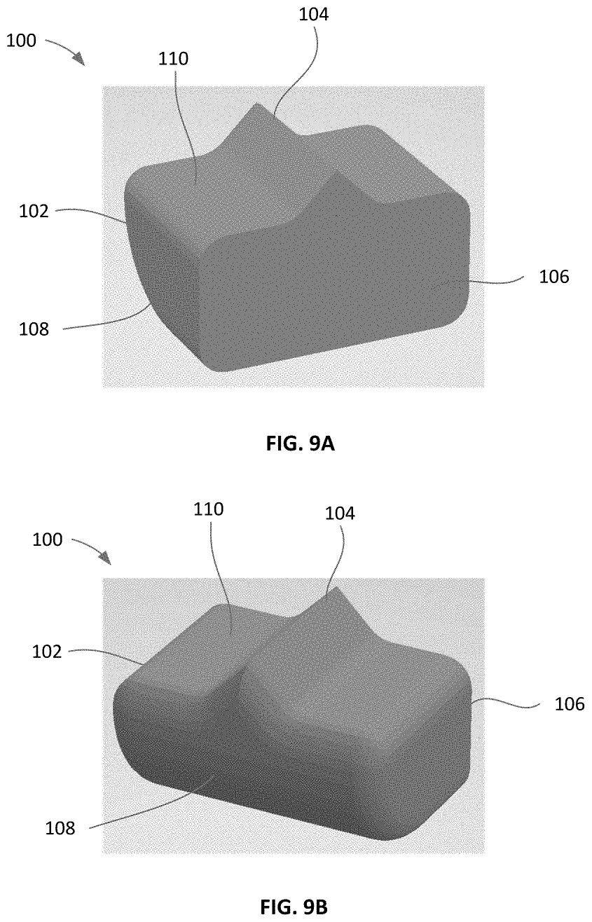

The bracket guide attachment members which may be positioned upon the digital model of the dentition or which may be attached or otherwise formed on a mold of the dentition (which may be scanned as a digital model), may be configured in different shapes. One variation is shown in the perspective views of FIGS. 9A and 9B which show a bracket guide attachment member 100 having a body 102 which presents a curved surface which projects from a relatively flattened attachment surface 106 for securement upon the crown surface. The body 102 may project from the attachment surface 106 and terminate in a curved or tapered outer surface 108. The top or occlusal surface 110 of the body 102 may form a relatively flattened surface perpendicularly formed relative to the attachment surface 106 and the indicator or projection 104 may extend from the top or occlusal surface 110 such that the indicator or projection 104 is formed as a tapered projection extending over the width of the occlusal surface 110.

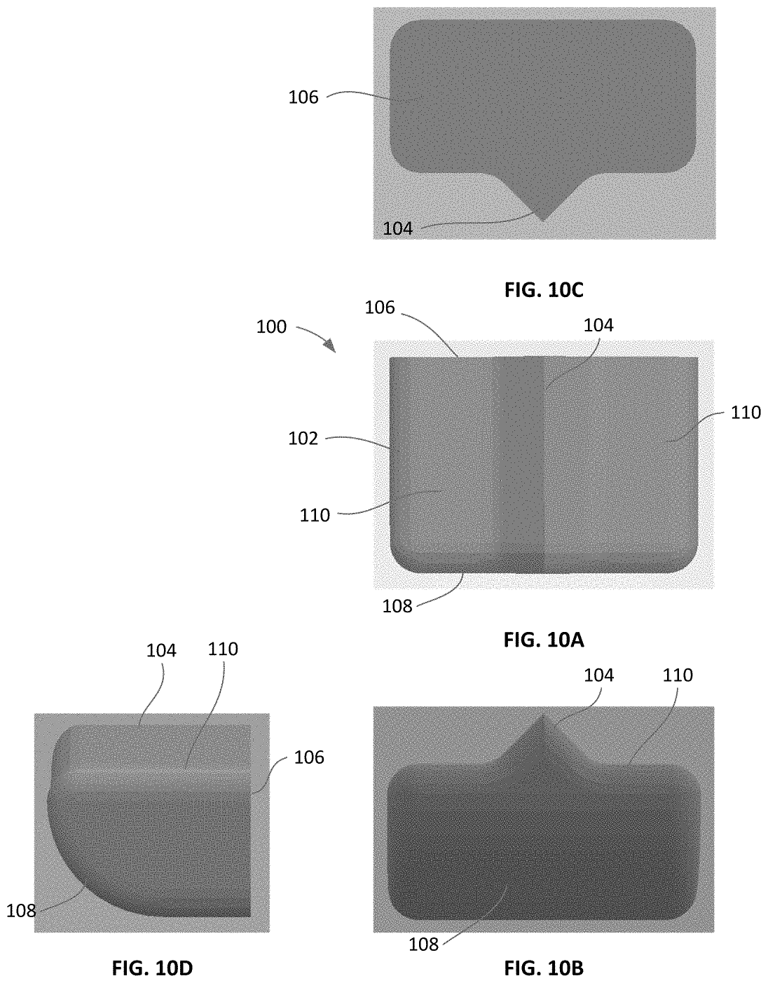

FIGS. 10A to 10D illustrate respective top, rear, front, and side views of the bracket guide attachment member 100 to illustrate each of the respective surfaces. As shown, the outer surface 108 may present a curved surface from the top or occlusal surface 110 and curving towards the attachment surface 106.

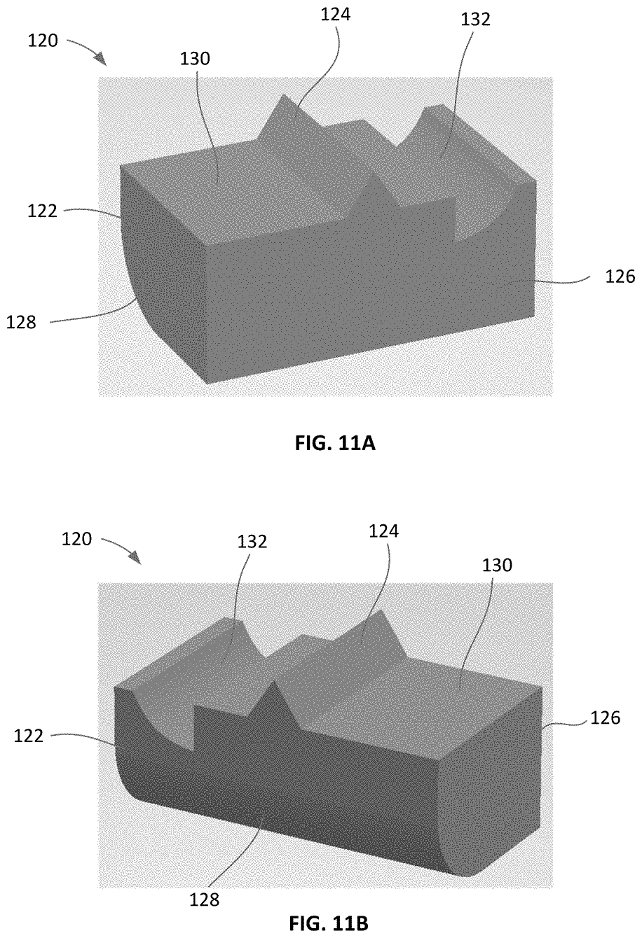

Another variation of the bracket guide attachment member 120 is shown in the perspective views of FIGS. 11A and 11B which show a bracket guide attachment member 120 having a body 122 which presents a curved surface which projects from a relatively flattened attachment surface 126 for securement upon the crown surface. The body 122 may project from the attachment surface 126 and terminate in a curved or tapered outer surface 128. The top or occlusal surface 130 of the body 122 may form a relatively flattened surface perpendicularly formed relative to the attachment surface 126 and the indicator or projection 124 may extend from the top or occlusal surface 130 such that the indicator or projection 124 is formed as a tapered projection extending over the width of the occlusal surface 130. In this variation, a groove or channel 132 may be defined along the occlusal surface 130 in which the channel 132 forms a shoulder which may form a corresponding shoulder in the template guide formed upon the attachment member 120 for facilitate placement of the bracket upon the crown.

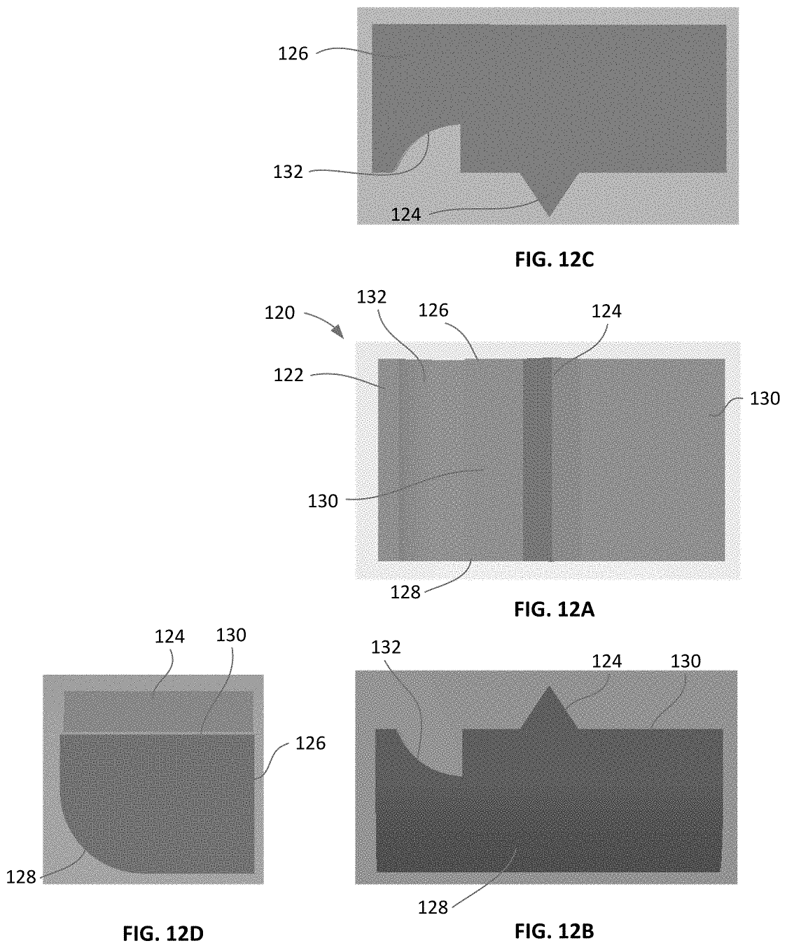

FIGS. 12A to 12D illustrate respective top, rear, front, and side views of the bracket guide attachment member 120 to illustrate each of the respective surfaces. As shown, the outer surface 128 may present a curved surface from the top or occlusal surface 130 and curving towards the attachment surface 126.

While different features are discussed, the system may incorporate any number of different features into a single system in any number of combinations. A single system provided may, for example, include or incorporate every feature described herein or it may include a select number of features depending upon the desired system.

The applications of the devices and methods discussed above are not limited to the one described but may include any number of further treatment applications. Modification of the above-described assemblies and methods for carrying out the invention, combinations between different variations as practicable, and variations of aspects of the invention that are obvious to those of skill in the art are intended to be within the scope of the claims.

What is claimed is:

1. A template guide for positioning an orthodontic attachment, comprising:
a formed body defining a receiving channel configured to conform to an occlusal surface of one or more teeth of a patient while a remainder of surfaces of the one or more teeth remain exposed; and
a reference surface or shelf extending along a length of the formed body and projecting at a predetermined angle, wherein the reference surface is configured for locating a bracket attachment upon the surfaces of the one or more teeth.

2. The template guide of claim 1 wherein the formed body is based upon a scanned image of the dentition.

3. The template guide of claim 1 wherein the reference surface or shelf forms a continuous surface along the length of the formed body.

4. The template guide of claim 1 wherein the reference surface or shelf defines a groove or mark positioned respectively at a mid-line of each of the one or more teeth.

5. The template guide of claim 1 wherein the reference surface or shelf extends along the length to project from a buccal surface or a lingual surface of the one or more teeth.

6. The template guide of claim 1 further comprising one or more bracket attachments for use with the reference surface or shelf.

7. The template guide of claim 6 further comprising an archwire engageable with the one or more bracket attachments.

8. The template guide of claim 1 wherein the reference surface or shelf provides for uninhibited lateral positioning of the bracket attachment upon the surfaces of the one or more teeth.

9. A method of forming a template guide for use with an orthodontic attachment, comprising:
receiving a digital model of one or more teeth of a patient;
positioning one or more attachments upon the one or more teeth within the digital model;
connecting the one or more attachments laterally along a three-dimensional line;
deriving a profile from an occlusal plane based on the three-dimensional line; and
extruding the profile towards a base of the digital model.

10. The method of claim 9 further comprising fabricating the template guide.

11. The method of claim 9 further comprising digitally correcting for one or more malocclusions of the one or more teeth prior to positioning the one or more attachments.

12. The method of claim 11 further comprising digitally positioning one or more bracket attachments upon the one or more teeth.

13. The method of claim 12 wherein positioning the one or more bracket attachments comprises determining a distance from an incisal edge of the one or more teeth to each of the one or more bracket attachments.

14. The method of claim 9 wherein connecting the one or more attachments laterally comprises forming a continuous line at a distance from each surface of the one or more teeth.

15. The method of claim 9 wherein extruding the profile comprises extruding the profile towards the base of the digital model in a gingival direction.

16. The method of claim 9 further comprising cutting the base of the digital model.
